(19) United States
(12) Patent Application Publication
(10) Pub. No.: US 2016/0183113 A1
(43) Pub. Date: Jun. 23, 2016

(54) EFFICIENT PAIRWISE RANGING TO NODES IN A LARGE CLUSTER

(71) Applicant: QUALCOMM Incorporated, San Diego, CA (US)

(72) Inventors: Praveen DUA, Cupertino, CA (US); Zhifeng CAI, Fremont, CA (US); Meghna AGRAWAL, Sunnyvale, CA (US); Andrew Mackinnon DAVIDSON, Monte Sereno, CA (US); Samir KAPOOR, Palo Alto, CA (US); Amod BODAS, Cupertino, CA (US)

(21) Appl. No.: 14/580,837

(22) Filed: Dec. 23, 2014

(51) Int. Cl. H04W 24/10; H04W 72/12; H04W 72/04

(52) U.S. Cl. CPC H04W 24/10; H04W 72/04; H04W 72/1278

(57) ABSTRACT

Mobile devices implement a ranging mechanism that includes a lead responder receiving ranging measurement requests from two different initiators in the same DW cycle. At the beginning of the DW cycle the lead responder broadcasts and/or publishes a channel availability map that includes a list of slots and channels in which to respond to the ranging measurement requests based on a number of ranging operations supported in each slot within the DW cycle and based on an autonomously determined response sequence. If the lead responder responds to all ranging requests by all initiators in a DW cycle, secondary responders can perform ranging in the same or subsequent DW cycles. Upon exhausting all initiators paired with the lead responder, a secondary responder becomes the “active” responder that is chosen based on a prioritization scheme that is universal among the group of devices in the ranging operation.

### FIELD OF DISCLOSURE

The technology described herein is directed to wireless communications networks, and in particular, to efficient pairwise ranging in wireless communications networks.

### BACKGROUND

With the proliferation of mobile devices usage of the mobile devices in a social context is increasing. In a common social context, there can be a large number of mobile devices in proximity to each other. Being able to determine where mobile devices are with respect to one another can be accomplished using RTT ranging. The Institute of Electrical and Electronics Engineers (IEEE) 802.11 standards specify how Wireless Fidelity (Wi-Fi) can be used to perform RTT ranging to determine the distance between a pair of mobile devices.

Current RTT ranging techniques work well but suffer from a few challenges. For example, Wi-Fi RTT ranging is asymmetric because at the end of a RTT ranging frame exchange only the initiator of the RTT ranging request is aware of the distance between itself and the responder.

Another challenge with conventional RTT ranging is that a responder cannot support RTT ranging exchanges from multiple initiators concurrently. A responder can only support RTT ranging exchanges from one initiator at a time.

A third challenge with RTT ranging is that a single mobile device can be performing several roles concurrently. For example, a mobile device can be an access point-station (AP-STA) that is connected to multiple access points (APs). At the same time, the mobile device can be a participant in a Wi-Fi-Direct connection performing Wi-Fi connections between other mobile devices in a peer-to-peer manner. Simultaneously, the mobile device could be working in the role of a soft access point (softAP) and have its own network. Concurrently, the mobile device could be a participant in Near-Me Area Network (NAN) connections such as a Social-WiFi network. Thus, there are many roles that a mobile device could be serving. This challenge can become even more difficult because each role that the mobile device is performing may be performed on a different channel, requiring the mobile device to hop between channels.

A fourth challenge is that mobile devices conserve power by aggressively entering into a “power save” mode.

For successful RTT ranging between a pair of mobile devices, both mobile devices ought to be on the same channel and out of power save mode. To the extent that traditionally there is a lack of any such coordination for the mobile devices in a large cluster, very poor RTT ranging and very inefficient power consumption profile results for the mobile devices.

### SUMMARY

One implementation of the technology described herein is directed to a method for ranging in a communication network. The method comprises receiving an N×N ranging measurement request from an upper layer entity and responding to the N×N ranging measurement request by advertising a channel availability map at a beginning of a discovery window (DW) cycle. The channel availability map includes a list of slots and channels.

The method also comprises receiving one or more ranging measurement requests from one or more initiators according to an initiator prioritization scheme and the channel availability map. The method also comprises responding to the ranging measurement requests from the one or more initiators.

Another implementation is directed to an apparatus for ranging in a communication network. The apparatus comprises logic configured to receive an N×N ranging measurement request from an upper layer entity and logic configured to respond to the N×N ranging measurement request by advertising a channel availability map at a beginning of a DW cycle. The channel availability map includes a list of slots and channels.

The apparatus also comprises logic configured to receive one or more ranging measurement requests from one or more initiators according to an initiator prioritization scheme and the channel availability map. The apparatus also comprises logic configured to respond to the ranging measurement requests from the one or more initiators.

Another implementation is directed to an apparatus for ranging in a communication network. The apparatus comprises means for receiving an N×N ranging measurement request from an upper layer entity and means for responding to the N×N ranging measurement request by advertising a channel availability map at a beginning of a DW cycle. The channel availability map includes a list of slots and channels.

The apparatus also comprises means for receiving one or more ranging measurement requests from one or more initiators according to an initiator prioritization scheme and the channel availability map. The apparatus also comprises means for responding to the ranging measurement requests from the one or more initiators.

Another implementation is directed to a computer-readable storage medium including data that, when accessed by a machine, cause the machine to perform operations in a wireless communication network comprising receiving an N×N ranging measurement request from an upper layer entity and responding to the N×N ranging measurement request by advertising a channel availability map at a beginning of a DW cycle. The channel availability map includes a list of slots and channels.

The operations also comprise receiving one or more ranging measurement requests from one or more initiators according to an initiator prioritization scheme and the channel availability map. The operations also comprise responding to the ranging measurement requests from the one or more initiators.

Above is a simplified Summary relating to one or more implementations described herein. As such, the Summary should not be considered an extensive overview relating to all contemplated aspects and/or implementations, nor should the Summary be regarded to identify key or critical elements relating to all contemplated aspects and/or implementations or to delineate the scope associated with any particular aspect and/or implementation. Accordingly, the Summary has the sole purpose of presenting certain concepts relating to one or more aspects and/or implementations relating to the mechanisms disclosed herein in a simplified form to precede the detailed description presented below.

### BRIEF DESCRIPTION OF THE DRAWINGS

FIG. 1 depicts a diagram of a broadband wireless communication network and RTT measurement of communications therein according to an implementation of the technology described herein.

FIG. 2 is a timing diagram illustrating operation of a broadband wireless communications network according to an implementation of the technology described herein.

FIG. 3 is a timing diagram illustrating operation of a broadband wireless communications network according to an alternative implementation of the technology described herein.

FIG. 4 is a diagram illustrating ranging for a group of mobile devices in a broadband wireless communications network according to an implementation of the technology described herein.

FIG. 5 is a timing diagram illustrating operation of a broadband wireless communications network according to an implementation of the technology described here.

FIG. 6 is a timing diagram illustrating operation of a broadband wireless communications network according to another implementation of the technology described here.

FIG. 7 is a flowchart illustrating a method for performing efficient pairwise ranging to mobile devices in a large cluster of a broadband wireless communications network according to an implementation of the technology described herein.

FIG. 8 is a flowchart illustrating a method for performing efficient pairwise ranging to mobile devices in a large cluster of a broadband wireless communications network according to an alternative implementation of the technology described herein.

FIG. 9 is a high-level block diagram of a system for performing efficient pairwise ranging to mobile devices in a large cluster according to an alternative implementation of the technology described herein

FIG. 10 is a block diagram of a broadband wireless communications network according to an implementation of the technology described herein.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

One or more implementations of the technology described herein enable improved round-trip time (RTT) ranging among mobile devices, in a large cluster, for example. In one implementation, one of the responders is designated as a lead responder and the remaining responders are designated as secondary responders. Both the lead responder and the secondary responders are capable of becoming active responders when it is their turn to do so.

In one implementations, the lead responder receives a RTT ranging request from an initiator. There are other initiators in the cluster, and each initiator autonomously determines its order for requesting RTT ranging measurements with the lead responder. The lead responder receives and accommodates the RTT ranging measurement requests from several initiators in the same DW cycle and in the order that is autonomously determined by the initiators.

This is facilitated by solving the challenges described above. For example, RTT ranging is made symmetric so that at the end of the RTT ranging frame exchange the initiator of the RTT ranging request and the responder both are aware of the distance between each other. Moreover, power is saved due to the fact that while the lead responder is receiving ranging requests from the various initiators, other nodes (i.e. responders and initiators) could be asleep. Initiators and responders need only be active when making ranging measurements. The technology described herein is also more efficient the various initiators can schedule when to transmit a ranging request to the lead responder using the channel availability map transmitted by the lead responder.

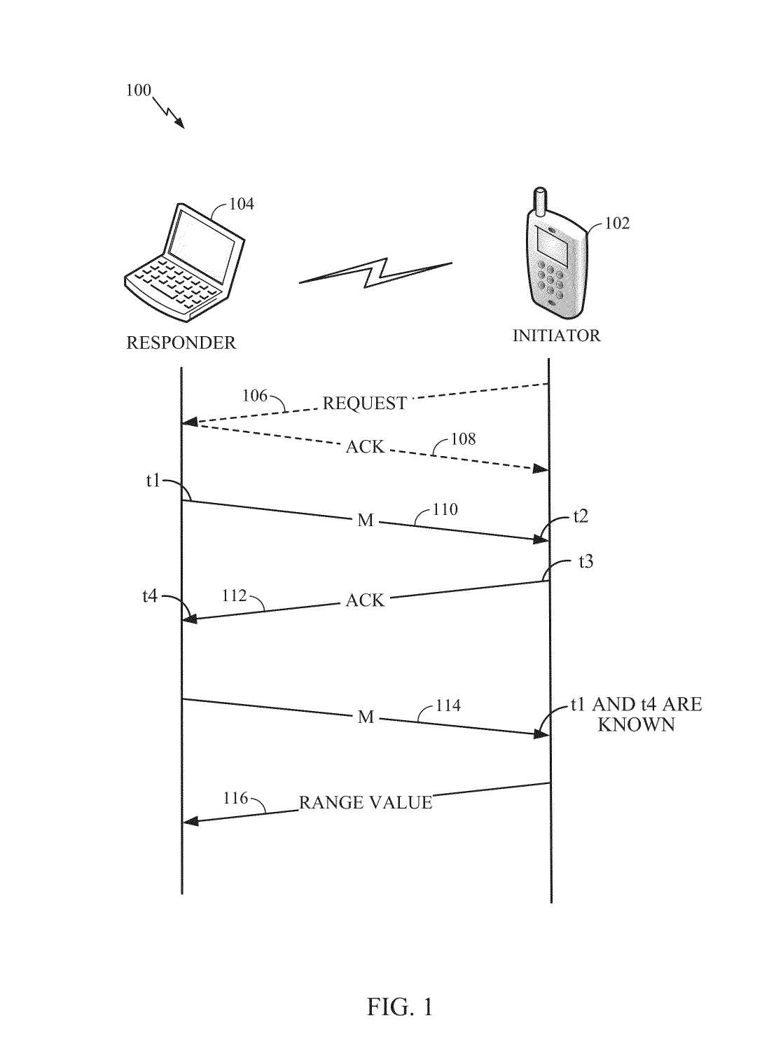

FIG. 1 depicts a diagram 100 of a broadband wireless communications network and RTT measurement of communications therein according to an example implementation of the technology described herein. The diagram 100 includes an initiator 102 and a responder 104. For purposes of explanation assume that the initiator 102 wishes to perform a ranging measurement with the responder 104.

In a conventional time-of-arrival (ToA)-based approach, the initiator 102 transmits an initial timing measurement request (REQUEST) 106 to request ranging to the responder 104. The responder 104 transmits an acknowledgement frame (ACK) 108 for that request. When the initiator 102 receives the ACK 108 the initiator 102 is aware of that the responder 104 has received the REQUEST 106.

Some time later, which time is indeterminate, if the responder 104 chooses to service the REQUEST 106 the responder 104 will transmit a timing measurement frame (M) 110 to the initiator 102. As the responder 104 transmits the timing measurement frame (M) 110 the responder 104 records the time of departure (ToD) time stamp t1 for the timing measurement frame (M) 110. When the timing measurement frame (M) 110 is received by the initiator 102, the initiator 102 will record a time stamp t2 as a time of arrival (ToA) of the timing measurement frame (M) 110.

The initiator 102 then transmits an ACK 112 to the responder 104. The ACK 112 has a time of departure (ToD) time stamp t3. The time of departure (ToD) time stamp t3 is recorded at the initiator 102. The responder 104 receives the ACK 112. The responder 104 records the time of arrival (ToA) time stamp t4.

After the first timing measurement frame (M) 110 exchange the next timing measurement frame (M) 114 that the responder 104 transmits to the initiator 102 merges the timestamps t1 and t4 as a part of the timing measurement frame (M) 114 so that by the time the second timing measurement frame (M) 114 reaches the initiator 102, the initiator 102 now has information about t1 and t4 of the previous exchange and timestamps t2 and t3.

At this point the initiator 102 is able to compute range to the responder 104 based on these four timestamps (t1, t2, t3, and t4). This helps in refining and averaging the result for a higher accuracy. This exchange is standardized as part of 802.11 and 802.11ac, and as a result facilitates interoperability among vendors that support the standard.

At the end of the frame exchanges, the initiator 102 is aware of what the range value is to the responder 104 but the responder 104 is not aware of what the range is to the initiator 102. This is because the responder 104 transmits only timing measurement frame (M) 110 and timing measurement frame (M) 114. The responder 104 never acquires access to times t2 and t3 from the initiator 102 and as a result cannot help with the ranging. In that sense, the ranging measurement scheme according to the IEEE 802.11 is asymmetric.

According to one or more implementations of the subject matter disclosed herein, the performance of ranging measurements between an initiator 102 and a responder 104 are symmetric. Because the initiator 102 is aware of what the range value is the initiator 102 can transmit this range value as range value 116 to the responder 104. The range value 116 can be transmitted by the initiator 102 to the responder 104 using a vendor-specific Information Element included in a Fine Timing Measurement (FTM) message. One such message can be an FTMStop frame. Thus, at the conclusion of the frame exchange the responder 104 also is aware of its range to the initiator 102. A Media Access Control (MAC) layer in the initiator 102 and the responder 104 may control the transmission of the frames back and forth.

According to one or more implementations of the subject matter disclosed herein, a lead responder may receive and accommodate the RTT ranging measurement requests from several initiators. In one implementation, the initiators are aware of an autonomous initiator prioritization scheme.

To illustrate, in an M×1 configuration in which M mobile devices wish to initiate ranging measurements to a single mobile device all of the M mobile devices will be aware of an autonomous prioritization scheme whereby each M mobile device knows when to attempt to perform ranging measurements with the one mobile device. Using the autonomous prioritization scheme may reduce interference among the several initiators and the ranging process may proceed in a smoother and more orderly fashion.

In one or more implementations, each of the M mobile devices is aware of the MAC addresses of the other M mobile devices. As a result, each of the M mobile devices can infer a common prioritization order for which of the M mobile devices is expected to go first. The autonomous prioritization scheme reduces the chances that all M mobile devices will attempt to transmit to the one mobile device, and interference is avoided. The result is a ranging process that proceeds in a smoother and more orderly fashion.

One autonomous initiator prioritization scheme determines which of the M mobile devices performs ranging measurements first by sorting MAC addresses of the M mobile devices in an order selected from an ascending order, a descending order, or an order selected using one or more hash functions. Of course, other prioritization schemes may be utilized as long as all M mobile devices follow the same scheme.

For example, if there is an implicit priority order or importance order due to the service running on the initiator, services that refresh more frequently could be given higher priority over services that refresh less frequently. In another example, if a web browser is initiating the ranging request on one initiator and a navigation application initiating the ranging request on another initiator, the navigation application could be given priority.

In one or more implementations, a lead responder may receive and accommodate RTT ranging measurement requests from several initiators in the same DW and in the order that is autonomously determined by the initiators. This allows a lead responder to support RTT ranging exchanges from multiple initiators concurrently. A ranging service and a channel availability map may be used to facilitate this.

To illustrate, according to a Near-Me Area Network (NAN) standard, mobile devices transmit beacons to advertise their services. The mobile devices may advertise their services by broadcasting and/or publishing. In the Near-Me Area Network (NAN) specification, time is divided into DW cycles. Each DW cycle is 512 milliseconds. Each DW cycle is divided into thirty-two slots of sixteen milliseconds each. In the first slot of each DW cycle, mobile devices broadcast/publish different beacons to advertise what services they offer, their ranging service attributes, timestamps, and so forth. The common slot 0 in a DW cycle establishes the Near-Me Area Network (NAN) network.

A ranging service is one of the Near-Me Area Network (NAN) services. When a mobile device is enabled for ranging, the mobile device announces or broadcasts and/or publishes a ranging service. The mobile device also broadcasts and/or publishes, either solicited or unsolicited, the ranging service by giving a time for when the mobile device will be available at a given channel in a given slot. A peer mobile device can subscribe to the Near-Me Area Network (NAN) ranging service to indicate that the peer mobile device is interested in ranging to the ranging service provider. The peer mobile device will then assume the initiator role. The mobile device providing the Near-Me Area Network (NAN) ranging service assumes the responder role.

A channel availability map is an Information Element that is advertised by a mobile device. The channel availability map is a list of slot numbers, channels, sub-channels, etc., for the mobile device, in the form of a table, for example, when the mobile device broadcasts and/or publishes its channel availability map. The channel availability map indicates when the mobile device will make itself available for ranging in the advertised slot number and channel. Any mobile device wishing to make a range measurement to the advertising mobile device can show up in the advertised slot number and initiate a ranging measurement (as initiator). The mobile device that broadcasts and/or publishes the channel availability map becomes available in the advertised slot and channel as a responder.

The ability for the lead responder to receive and accommodate the RTT ranging measurement requests from several initiators in the same DW and in the order that is autonomously determined by the initiators is also facilitated by multiplexing the RTT ranging so that each responder can support RTT ranging from multiple initiators concurrently.

Traditionally, one limitation of the 802.11 Wi-Fi specifications is that a device cannot perform an initiator role and a responder role simultaneously. According to one or more implementations of the technology described herein, a mobile device can be both initiator and responder concurrently to provide multiplexed ranging. Each responder may support ranging exchanges from multiple initiators concurrently in an overlapped/interleaved manner. In one or more implementations of the technology described herein, a responder may support a frame exchange sequence from multiple initiators in an overlapped manner, taking into consideration the medium availability and the carrier sense collision avoidance provided in the 802.11 Wi-Fi specifications.

The ability for the lead responder to receive and accommodate the RTT ranging measurement requests from several initiators in the same DW and in the order that is autonomously determined by the initiators is also facilitated by sharing knowledge of maximum ranging operations among mobile devices. For example, if M mobile devices are aware of how many concurrent initiators, (P), a single responder can support at a given time, up to P initiators can actually begin ranging measurements substantially simultaneously. In this manner, P initiators can attempt to range to the one responder altogether and the ranging measurements will successfully conclude. The ranging measurement requests from the first initiator and the one or more initiators may be received by the one responder substantially simultaneously as well.

The number of initiators (P) that the one responder can support at a given time may depend on the vendor of the mobile device. The number of initiators (P) that the one responder can support at a given time also may depend on the generation (e.g., 3G, 4G, etc.) of the mobile devices. Of course, any scheme for how many initiators a responder can support may be utilized. Moreover, the scheme for how many initiators a responder can support may be advertised as part of the ranging service beacon in addition to identifying its slot number and channel.

The autonomous initiator prioritization scheme applies to M mobile devices wanting to range to one responder. The M mobile devices can follow the autonomous initiator prioritization scheme for that responder.

In alternative implementations, there may be an M×M exchange where there are multiple M responders instead of one responder. In the M×M exchanges, the responders identify a priori which mobile device is available and in what order. It becomes quite inefficient, however, if all responders are made available all the time merely because all responders are out of power save mode.

To ameliorate this inefficiency, each DW cycle has one explicit lead responder. The lead responder broadcasts and/or publishes its channel map availability at the beginning of the DW cycle. That is, the lead responder broadcasts and/or publishes which channels and slots it has available. The lead responder also broadcasts and/or publishes the number of P initiators that it can support. The rest of the mobile devices in the ranging group based on the channel maps advertised will compute the order in which they themselves are to initiate ranging to the lead responder by following the autonomous initiator prioritization scheme that is being used. In each of the slots that is advertised by the lead responder, starting with the first slot, at least P initiator mobile devices initiate ranging to the lead responder according to their ranging order in the autonomous initiator prioritization scheme. Each device is aware of the value of P based on the broadcast parameters from the lead responder.

There also may be secondary responders for the DW cycle. If there are M initiator mobile devices that want to range to a responder mobile device, and the responder mobile device can support P concurrent initiator mobile devices in a slot, then it will take at least M/P number of slots to conclude that particular ranging measurement. The secondary responders also receive the channel availability map that was advertised by the lead responder, and thus are aware of how many slots are available and at which slot the lead responder is going to be available. Once the M/P number of slots is consumed out of the list from the lead responder, then all the mobile devices in the group of responders expect that the ranging measurements to the lead responder have largely been concluded.

At this point the remaining responders can begin taking on the role as secondary responders in the order of their ranking according to the autonomous initiator prioritization scheme. Thus, when the first secondary responder is aware of its slot to begin ranging measurements after M/P number of slots from the channel availability map have been consumed, the first secondary responder can begin becoming available. The other initiators that wish to perform ranging to the secondary responders are aware of which slots these secondary responders are going to be coming available in and these initiators can begin their ranging operations there. Thus, at this point the burden passes to the secondary responders to make themselves available at the after the first M/P slots are consumed.

Based on this, each responder computes which advertised slot from the lead responder's channel availability map that they themselves are expected to become available as a responder. The responders make the best effort to make themselves available as secondary responders at those computed slots. The remaining initiators that wish to range to a secondary responder follow a similar scheme and determine which slots they expect a secondary responder to become the lead responder at that point. Those slots are where the initiators and secondary responders perform frame exchanges.

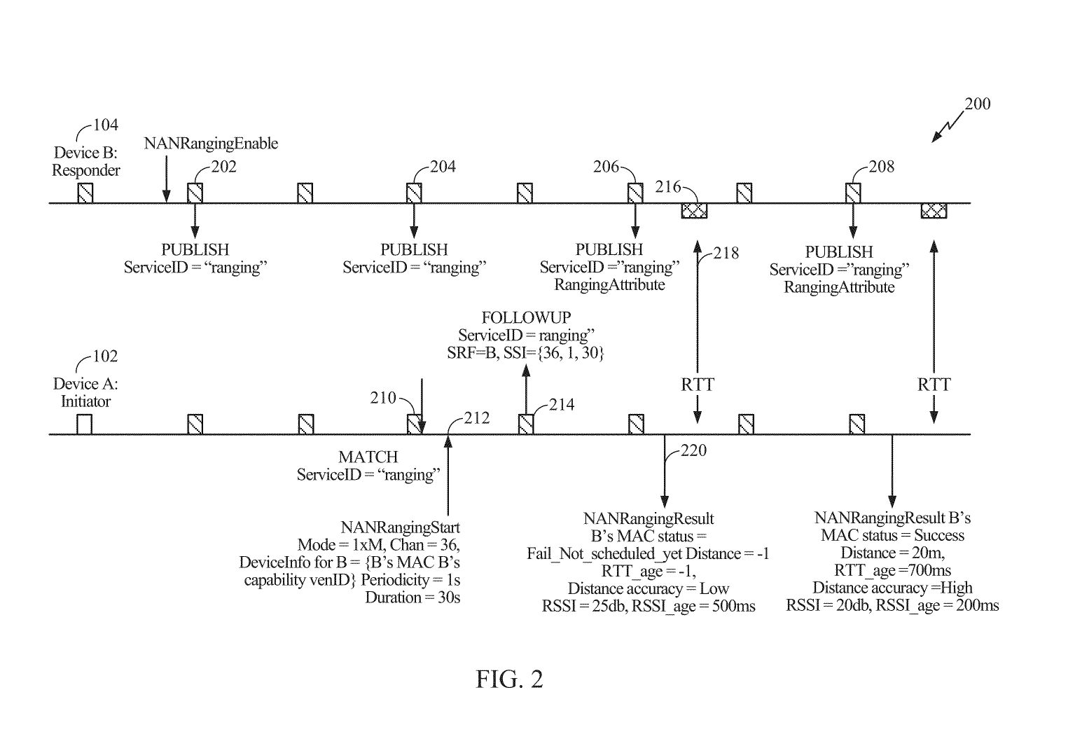

FIG. 2 is a timing diagram 200 illustrating operation of a broadband wireless network according to an example implementation in which one mobile device wants to range to another mobile device. The timing diagram 200 includes the initiator 102 and the responder 104. The timing diagram 200 also includes a point 202, a point 204, a point 206, and a point 208. The timing diagram 200 also includes a point 210, a point 212, a point 214, a slot 216, a point 218, and a point 220. The points 202, 204, 206, and 208 represent beacons transmitted by the responder 104.

For purposes of explanation, assume that the initiator 102 wants to range to the responder 104. At the point 202, the responder 104 broadcasts and/or publishes its ranging service in a beacon and may continue to publish its ranging service either in every DW cycle at the point 204, the point 206, and the point 208. The ranging service may be advertised in the first slot of the DW cycle. Of course, the responder 104 does not have to publish its ranging service every in every DW cycle.

At the point 210, the initiator 102 receives the published/broadcast ranging service and determines that it wants to perform a ranging to the responder 104.

At the point 212, an application programming interface (API) from an application layer in the initiator 102 is called to begin the Near-Me Area Network (NAN) ranging to the responder 104.

At points 214 and 206, the initiator 102 and the responder 104 exchange information about the ranging attributes and the channel availability maps. For example, the initiator 102 and the responder 104 exchange information regarding which channels are coming available and at which time slots.

In the slot 216, the responder 104 makes itself available for ranging, and, at the point 218, the initiator 102 begins exchanging frames with the responder 104. The ranging the result is obtained and at the point 220 is passed up to the application layer.

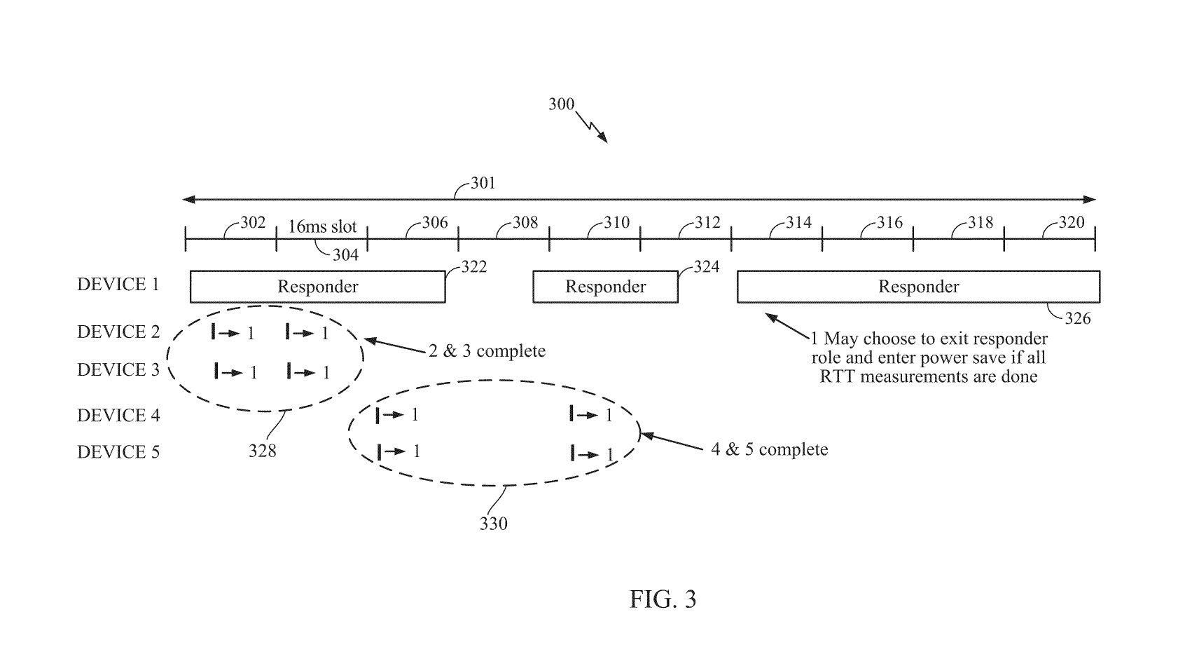

FIG. 3 is a timing diagram 300 illustrating operation of a broadband wireless communications network according to an example implementation in which M mobile devices want to range to one mobile device. To scale from the 1×1 configuration depicted in FIG. 2 to an M×1 configuration depicted in FIG. 3, the ranging mechanism considers one DW cycle 301.

The illustrated DW cycle 301 includes a slot 302, a slot 304, a slot 306, a slot 308, a slot 310, a slot 312, a slot 314, a slot 316, a slot 318, and a slot 320. The timing diagram 300 also includes a mobile device DEVICE 1, a mobile device DEVICE 2, and mobile device DEVICE 3, a mobile device DEVICE 4, and a mobile device DEVICE 5. The timing diagram 300 also includes a responder 322, a responder 324, and a responder 326.

For purposes of explanation, assume that the mobile device DEVICE 1 is the responder 322, and the responder 322 is the lead responder. Assume further that the responder 322 has advertised that it can handle two concurrent mobile devices (simultaneous initiators) in the slot 302. Thus, for the responder 322 P=2.

Because the responder 322 as lead responder has advertised that P=2 for the first slot 302, the mobile device 2 and the mobile device 3 determine their order for initiating ranging to the responder 322 in the first slot 302 using the autonomous initiator prioritization scheme described above. Assume further that according to the autonomous initiator prioritization scheme the mobile device DEVICE 2 is to be the first initiator to the responder 322 and the mobile device DEVICE 3 is to be the second initiator to the responder 322.

The mobile device DEVICE 2 and the mobile device DEVICE 3 begin the ranging measurement at a point 328. At the same time, the mobile device DEVICE 4 and the mobile device DEVICE 5 are aware that it is not their turn to range to the responder 322. The mobile device DEVICE 4 and the mobile device DEVICE 5 remain quiet in this first slot 302.

When the mobile device DEVICE 4 and the mobile device DEVICE 5 determine that M/P slots have elapsed, the mobile device DEVICE 4 and the mobile device DEVICE 5 can begin transmitting frames to the responder 322 to begin ranging operations. The mobile device DEVICE 4 and the mobile device DEVICE 5 are aware of which slots were advertised by the responder 322 and will transmit in those slots.

At a point 330, if all of the initiators that were expected to range to the lead responder 322 have concluded, the lead responder 322 a can enter into a power save mode. Otherwise, if all of the ranging measurements have not concluded then the lead responder 322 may choose to remain active.

Also at the point 330, the mobile device DEVICE 4 and the mobile device DEVICE 5 determine their initiating order for the slots 306, 308, and 310 using the autonomous initiator prioritization scheme described above. Using the autonomous initiator prioritization scheme the mobile device DEVICE 4 may determine that it is to be the first initiator and the mobile device DEVICE 5 determines that it is to be the second initiator to the responder 322 for the slots 306, 308, and 310. The mobile device DEVICE 4 and the mobile device DEVICE 5 begin the ranging measurement at the point 330.

Handling of 1×N scenarios where one mobile device wants to perform ranging measurements to N mobile devices as opposed to the previous case of an M×1 scenario involves one initiator and multiple responders. In one implementation, either the cloud or the application layer can handle N different 1×1 requests. However, this approach may not be very efficient. As used herein, the term “cloud” is intended to mean any entity that resides above the level of the Wi-Fi drivers and has a means of exchanging information with other mobile devices. The mechanism may depend upon how vendors put the ranging framework into place so that information is disseminated across the multiple mobile devices according to policies that are in place.

In an alternative implementation, the cloud or the application layer issues a “RangingStart” command on the single mobile device that is to range with the other N mobile devices. The single mobile device can then transmit a vendor-specific message to the N other mobile devices, requesting to be ranged by them in their initiator roles. The vendor-specific message may be transmitted in N separate unicast messages (one message to each of N mobile devices). Alternatively, there may be a broadcast message transmitted indicating target recipients.

Alternatively, in the first slot of a DW cycle a Bloom filer may be used to indicate which target recipient mobile devices should receive a broadcast message. Using a known Bloom filter may make the process more efficient because all mobile devices determine that they ought to initiate ranging based on the Bloom filter settings.

Once the vendor-specific message is successfully exchanged, the 1×N scenario effectively reduces to an N×1 scenario and may be handled in the same manner as the M×1 scenario described in FIG. 3 above.

To implement ranging for large N×N group of mobile devices, the N×N group may be broken down into meaningful RTT-tuples of M×1 scenarios or M×M scenarios. If N is very large, then all N mobile devices may not receive transmissions from all other N mobile devices. They each may only receive transmissions from sub-groups or sub-clusters.

The sub-clusters that emerge may depend upon the relative received signal strength (RSSI) and the proximity of the other mobile devices to each other. The mobile devices may assess the relative received signal strength (RSSI) based on the transmitted beacons as well as any other interaction frames that are transmitted, received, and developed by the signal strength. The mobile devices may perform an early triage determining how many different sub-clusters exist and whether there are mobile devices with different roles: roles as service provider or a subscriber.

An upper layer application in the mobile device may communicate what the RTT-tuples are. The upper layer application may then transmit ranging commands within the RTT-tuples that are the entities that wish to make ranging to each other. Sometimes one mobile device requests a measurement to another mobile device that is far enough away that the received signal strength indicator (RSSI) signal is never recorded. This may be because, during advertising of a slot of a DW cycle, if one mobile device does not receive transmissions from the other mobile device, the first mobile device may assume that the second mobile device is not in its range. In this case, the first mobile device will exclude trying to range to the second mobile device.

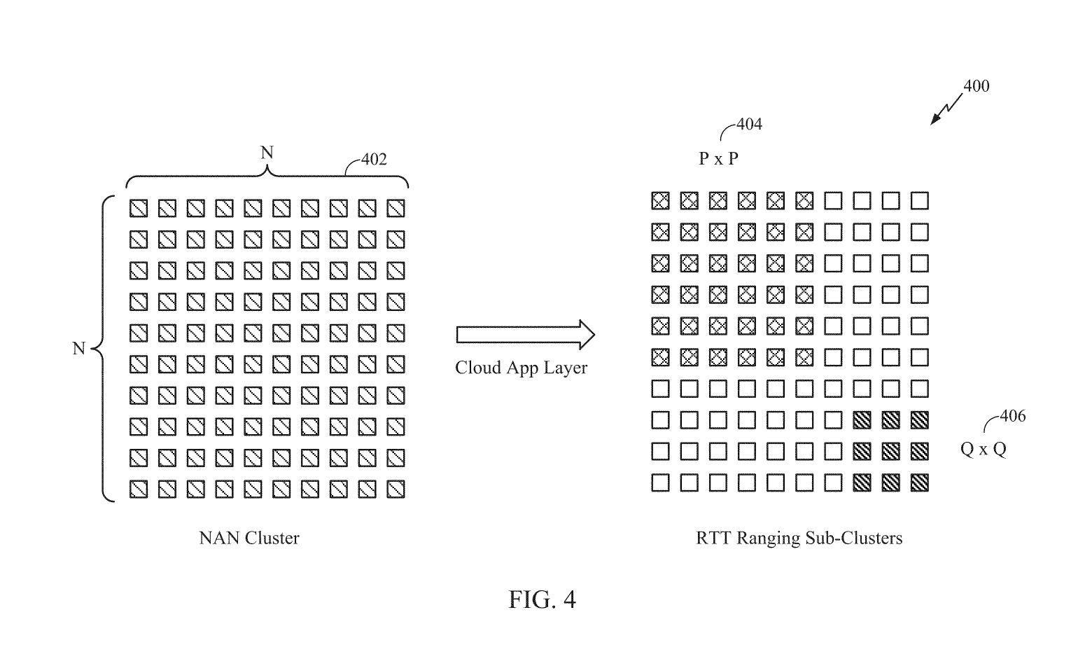

FIG. 4 is a diagram 400 illustrating ranging for a large N×N group of mobile devices according to one or more implementations of the technology described herein. In the illustrated implementation, there is a large number of N mobile devices in a Near-Me Area Network (NAN) N×N cluster 402. However, based on their proximity and other factors the large number of N mobile devices may break down into smaller sub-groups (P×P 404 or Q×Q 406). The sub-cluster make-up may be exchanged with an application in the cloud layer that can communicate with other mobile devices that are in the P×P 404 sub-cluster. One communication may be the MAC addresses of the other mobile devices in the sub-cluster.

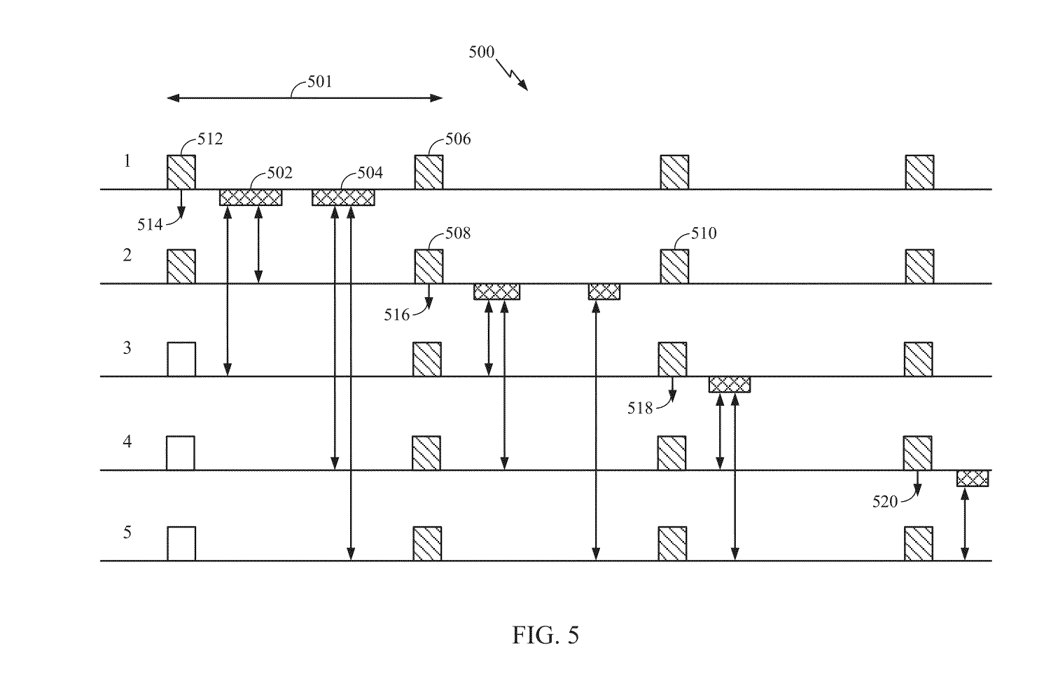

FIG. 5 is a timing diagram 500 illustrating timing for handling of an M×M Scenario according to one or more implementations of the technology described here. The illustrated timing diagram 500 includes a DW cycle 501, a slot 502, and a slot 504 in the DW cycle 501. The timing diagram 500 also includes a DW cycle begin/end point 506, a DW cycle begin/end point 508, a DW cycle begin/end point 510, and a DW cycle begin/end point 512. The timing diagram 500 also includes a beacon 514, a beacon 516, a beacon 518, and a beacon 520.

In one implementation of the illustrated M×M scenario, a common coordinating entity may issue the same NANRangingStart command on all mobile devices. The NANRangingStart command may indicate that it is operating in an M×M mode. In this manner, each mobile device is aware of the list of initiator MAC addresses and the list of responder MAC addresses.

Based on the autonomous initiator prioritization scheme described above, the mobile devices take turns to become the lead responder on a rolling basis and advertise their ranging attributes to indicate their availability for ranging (similar to M×1 case). This helps to reduce the number of channel availability maps that are transmitted in the same DW cycle from multiple responders.

In one or more implementations, one mobile device becomes the lead responder in the first DW cycle 501, for example. If the ranging exchanges are performed sooner (i.e., in the slot 502) the rest of the DW cycle 501 is not wasted and other mobile devices may come up as secondary responders and conclude their ranging in the slot 504.

At the DW cycle begin/end point 506 if another mobile device wishes to become a responder, the other mobile device becomes a lead responder and broadcasts and/or publishes its channel availability map. The calculations for that DW cycle are based on the channel availability map specified by this lead responder (at the DW cycle begin/end point 508). Additionally, for the next DW cycle another device becomes the next lead responder at the DW cycle begin/end point 510.

This technique in FIG. 5 helps to reduce the number of broadcast channel availability maps from different multiple responders. Thus, rather than every responder attempting to advertise that they are available in the slot 502 of the DW cycle 501 the responders take turns. Advantageously, this technique takes about the same amount of time because the same number of RTT exchanges can successfully occur on a given channel because the channel is a shared medium. Additionally, the same amount of time elapses, and the process is more orderly in an autonomous way so that power, interference, and other metrics may become optimized.

In sum, the responder attempts to allocate sufficient availability from its side to complete the ranging measurements with all initiators because once the responder receives the NANRangingStart command the responder is aware of the initiators that want to perform ranging measurements to it, i.e., how many initiators there are going to be and how many it can handle at a time concurrently. Based on that, the responder may determine how many slots are needed to service the initiators. The responder then broadcasts and/or publishes this information in the beacons 514, 516, 518, and 520.

With the timing diagram 500 the total time it takes to complete full M×M ranging is about M times the time it takes for one DW cycle using brute force.

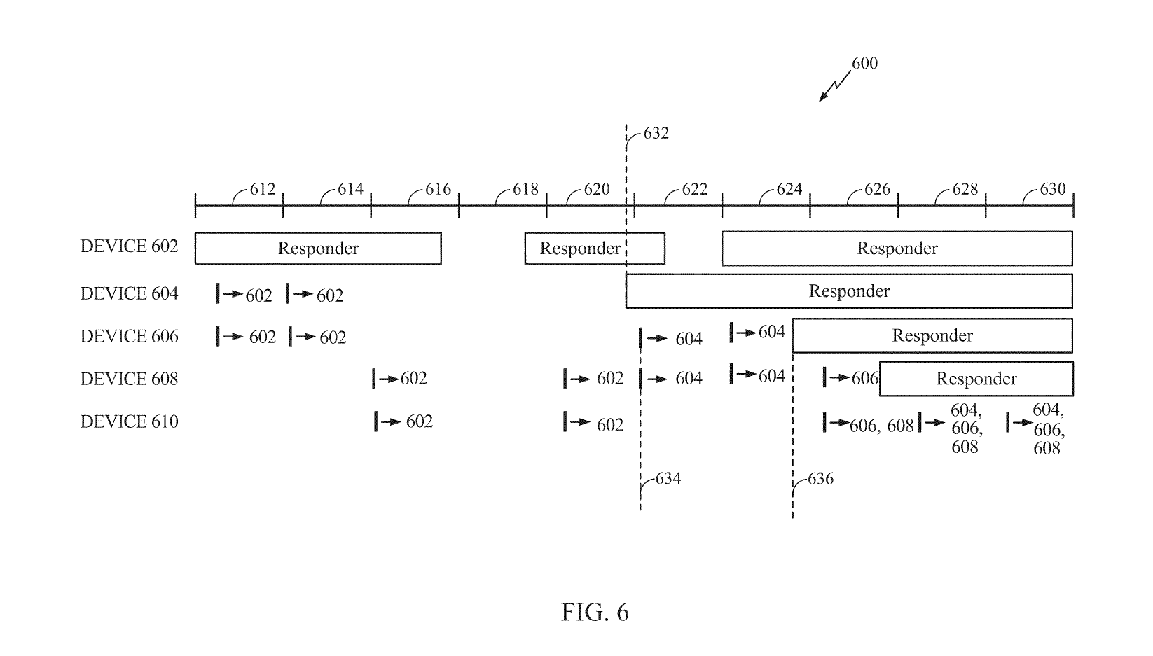

FIG. 6 is a timing diagram 600 illustrating operation of a broadband wireless communications network according to an example implementation in which ranging in an M×M configuration is shown. The timing diagram 600 illustrates mobile devices 602, 604, 606, 608, and 610. The timing diagram 600 also illustrates several slots 612, 614, 616, 618, 620, 622, 624, 626, 628, and 630. The slots 612, 614, 616, 618, 620, 622, 624, 626, 628, and 630 make up a DW cycle.

In the illustrated implementation, the mobile device DEVICE 602 is the lead responder at advertised channels. The mobile device DEVICE 604 and the mobile device DEVICE 606 are initiators that transmit ranging measurement requests to the mobile device DEVICE 602 in the order in determined by the autonomous initiator prioritization scheme described herein.

When the mobile device DEVICE 604 and the mobile device DEVICE 606 have performed their ranging measurements, the mobile device DEVICE 604 as a secondary responder autonomously is aware that the slot 620 is about to wake up and start becoming available, and can begin responding to ranging measurement requests by initiators as the active responder. As such, the mobile device DEVICE 604 as a secondary responder makes itself available for the duration of slots 620 through 630 to power up, come out of power save mode, and staying in a receive mode to listen for initiators. The mobile device DEVICE 604 as secondary responder is not actively transmitting. However, the mobile device DEVICE 604 as a secondary responder is consuming more power than it would have had it remained in a power save mode because remaining in a receive mode consumes more power than remaining in a power save mode.

In any event, power consumption may be reduced because the mobile device DEVICE 604 does not have to stay awake from the first DW slot 612. It does not come on line until DW slot 620.

For the M×M configuration the mobile device DEVICE 604 would generally want to make ranging measurements to the mobile device DEVICE 602. Also, the mobile device DEVICE 606 wants to make measurements to mobile device DEVICE 602.

When the ranging measurement exchanges are done symmetrically there are two advantages. After the ranging measurement requests are initiated and responded to during DW slot 612, both the mobile device DEVICE 604 and the mobile device DEVICE 602 are aware of the range to each other and both the mobile device DEVICE 602 and the mobile device DEVICE 606 are aware of the ranges to each other. Hence, later, if and when the two mobile devices DEVICE 604 and/or DEVICE 606 become secondary responders (after the lead responder has responded to all ranging measurement requests), the lead responder does not need to initiate a ranging measurement request with now-secondary responder (in this example, mobile devices 604 and/or 606).

Moreover, the mobile devices DEVICE 604 and/or DEVICE 606 can attempt their ranging measurements in the two slots 612 and 614 so that if for whatever reason the mobile devices DEVICE 604 and/or DEVICE 606 did not conclude the ranging measurements in slot 612 the mobile devices DEVICE 604 and/or DEVICE 606 still have another slot 614 to try to conclude the ranging measurements. By the time these measurements at slot 612 are concluded, the mobile devices DEVICE 604 and/or DEVICE 606 are aware of the range to mobile device DEVICE 602 and vice versa.

Thus, what remains is for mobile devices 604 and 606 to make ranging measurements to each other. At point 632 when mobile device DEVICE 604 becomes the (secondary) responder, mobile device DEVICE 606, as an initiator, initiates a ranging measurement request with mobile device DEVICE 604 as the secondary responder at a point 634. Similarly, mobile device DEVICE 608, as an initiator, initiates a ranging measurement request to initiate ranging measurements with mobile device DEVICE 604 as the secondary responder.

At a point 636 when the mobile device DEVICE 606 comes on line the mobile device DEVICE 608 will make ranging measurements to mobile device DEVICE 610 and mobile device DEVICE 604. By staggering when the mobile devices come on line the ranging mechanism operates in a more coordinated fashion and with reduced power consumption.

The secondary responder (e.g., mobile device DEVICE 604, 606, and/or 608) may publish its ranging attribute in one of the early slots that other mobile devices may be attempting to range to so that the secondary responder can receive it. For example, instead of staying on during the time in the channel availability map that was advertised by the lead responder the secondary responder may bring about further optimization for power consumption by advertising its own channel availability map at point 636 if it happens to differ from the lead responder.

As a further optimization for power consumption, each responder can decide to enter a power save mode, and stop being available as a responder for ranging, once it has successfully completed all of the ranging measurements. The responder does not have to stay on until the end of the DW cycle.

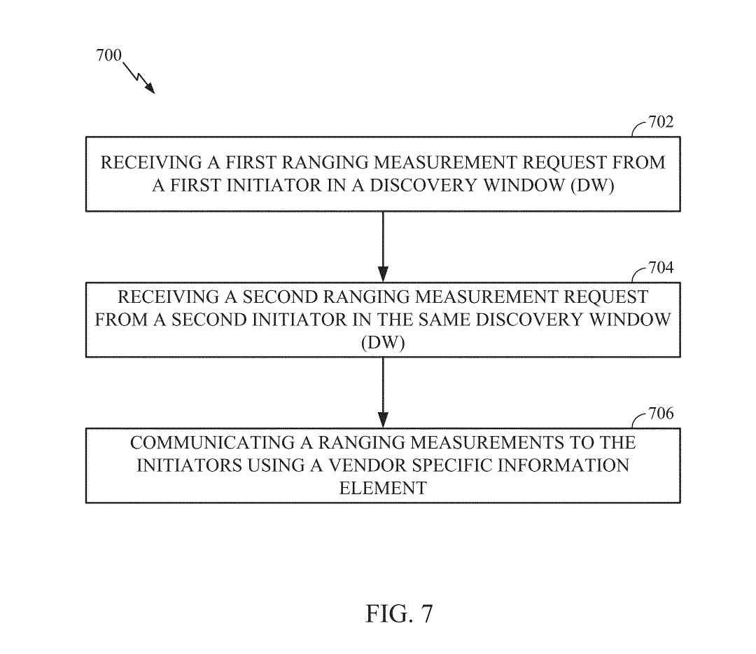

FIG. 7 is a flowchart illustrating a method 700 for performing efficient pairwise ranging to mobile devices in a large cluster according to an implementation of the technology described herein.

In a block 702, the method 700 receives a first RTT ranging request from a first initiator in a DW cycle. In one or more implementations, the mobile device DEVICE 602 receives a RTT ranging request from the initiator 604.

In a block 704, the method 700 receives a first RTT ranging request from a first initiator in a DW cycle. In one or more implementations, the mobile device DEVICE 602 receives a RTT ranging request from the initiator 606.

In a block 706, the method 700 communicates RTT ranging measurement value to the first initiator in a vendor-specific Information Element. In one or more implementations, the mobile device DEVICE 602 communicates a range value, such as the range value 116 computed by the initiator 102, to the mobile device DEVICE 604 using an FTMStop frame or other vendor-specific Information Element included in a Fine Timing Measurement (FTM) message.

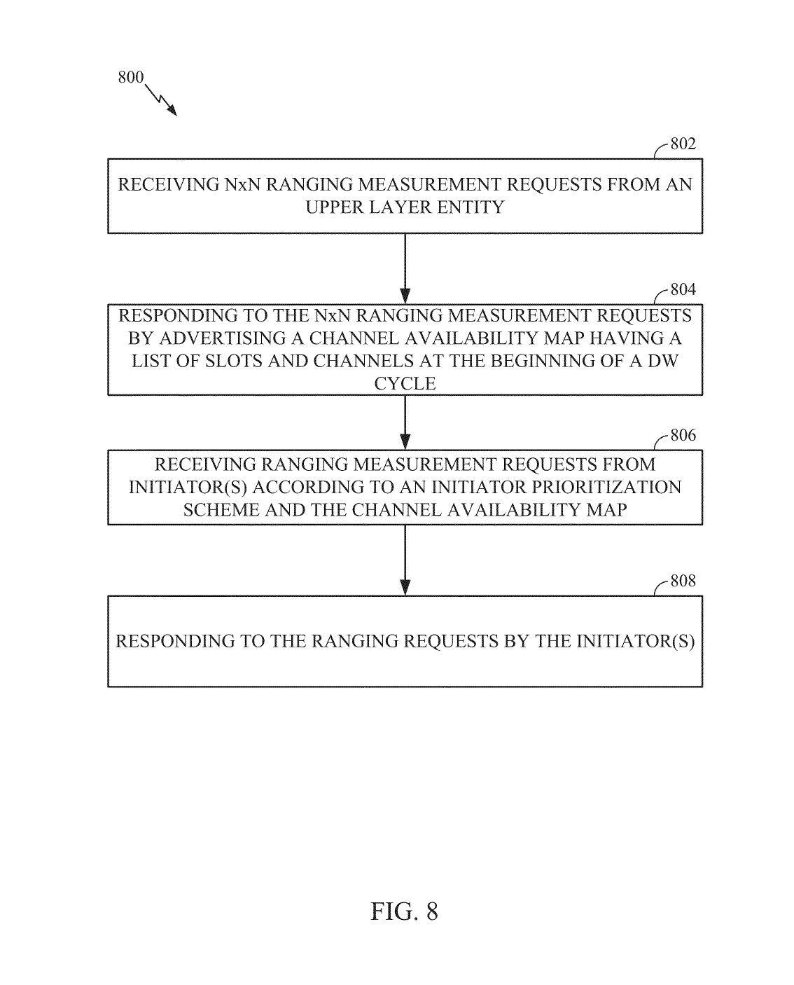

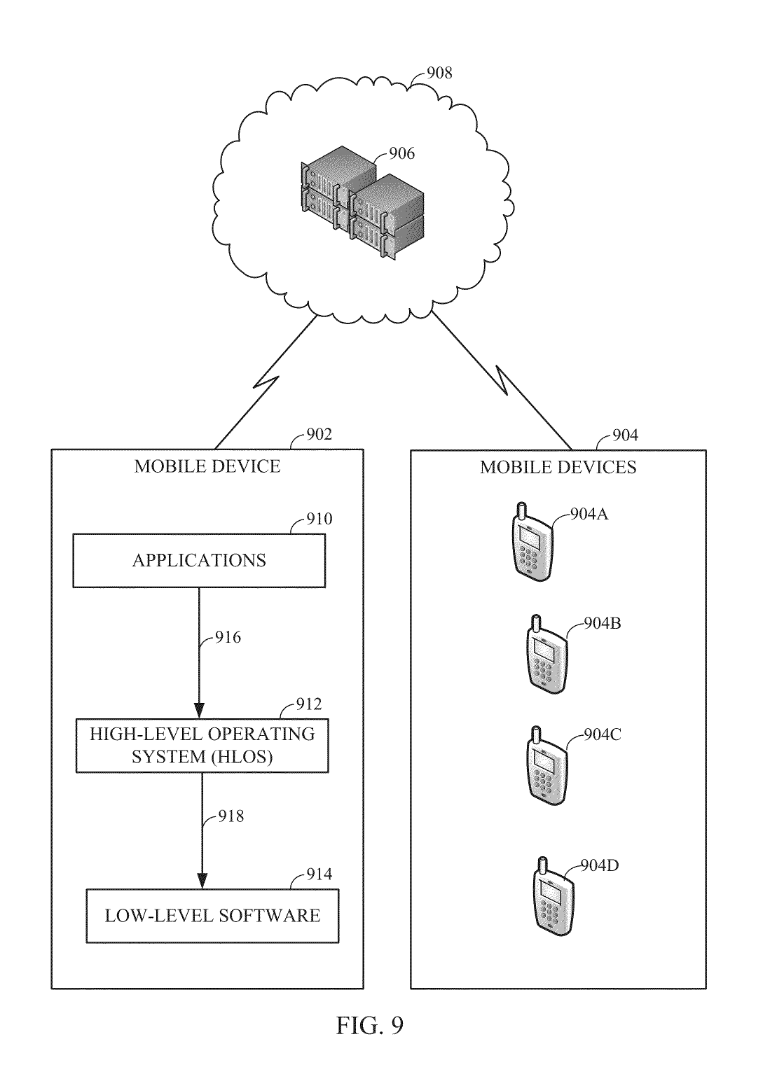

FIG. 8 is a flowchart illustrating a method 800 for performing efficient pairwise ranging to mobile devices in a large cluster according to an alternative implementation of the technology described herein. The method 800 is described with reference to FIG. 9, which is a high-level block diagram of a system 900 for performing efficient pairwise ranging to mobile devices in a large cluster according to an alternative implementation of the technology described herein.

The illustrated system 900 includes a mobile device 902 and one or more mobile devices 904 (enumerated as 904A, 904B, 904C, and 904D). The illustrated system 900 also includes an upper layer entity 906, located in the cloud 908, for example. The illustrated mobile device 902 includes one or more upper level applications 910, a high-level operating system (HLOS) 912, and low-level software (LLSW) 914. In one or more implementations, the LLSW 914 manages the DW cycle, advertises the channel availability map, and manages the responder/initiator role and prioritization.

To explain the operation of the system 900, suppose that five friends, or a family, are at a movie theater, and their mobile devices 902, 904A, 904B, 904C, and 904D are all previously paired and are aware of each other. In the movie theater, the mobile devices 902, 904A, 904B, 904C, and 904D read fifty or hundreds of neighboring mobile devices.

One of the friends or family members, Kent, wants to perform ranging to one of the other mobile devices 904A, 904B, 904C, or 904D. Kent's mobile device 902 has one of an upper layer application 910 on his mobile device 902 titled “Find my Family/Friends.” Kent presses a button on his mobile device 902 and the upper layer application 910 displays a map to all the other family/friend members that are within a peer-to-peer ranging communication range. Once Kent presses this button, the upper layer application 910 sends an N×N ranging request to the HLOS 912 on a link 916, which forwards it down to the LLSW 914 on a link 918. Kent's mobile device 902 also can communicate with the communication entity 906 located in the cloud 908.

In a block 802, the method 800 receives the N×N ranging measurement request from the upper layer entity. In one or more implementations, the upper level application 910 in Kent's mobile device 902 receives the N×N ranging measurement request from the upper layer entity 906 located in the cloud 908. The upper level application 910 in Kent's mobile device 902 sends the N×N ranging measurement request to the HLOS 912, which forwards the N×N ranging measurement request to the LLSW 914.

In a block 804, the method 800 responds to the N×N ranging measurement request by advertising a channel availability map at the beginning of a DW cycle. In one or more implementations, the LLSW 914 advertises the channel availability map at the beginning of a DW cycle. The channel availability map includes a list of slots and channels. In one implementation, the mobile device (i.e., 904A, 904B, 904C, or 904D) that responds to the N×N ranging measurement request is the lead responder.

In one implementation, the mobile device 904A, 904B, 904C, or 904D that responds as the lead responder may use its own prioritization scheme to respond. Alternatively, the mobile device 904A, 904B, 904C, or 904D that responds as the lead responder may use the autonomous initiator prioritization scheme described above such that first mobile device in the autonomous initiator prioritization scheme becomes lead responder and the first initiator then is the second responder in the autonomous initiator prioritization scheme. Alternatively still, the mobile device 904A, 904B, 904C, or 904D that responds as the lead responder may be random (e.g., whichever mobile device happens to be first to respond.)

One autonomous initiator prioritization scheme determines which of the M mobile devices performs ranging measurements first by sorting MAC addresses of the M mobile devices in an ascending order, a descending order, or using one or more hash functions. Of course, other prioritization schemes may be utilized as long as all M mobile devices follow the same scheme. For example, if there is an implicit priority order or importance order due to the service running on the initiator, services that refresh more frequently could be given higher priority over services that refresh less frequently. In another example, if a web browser is initiating the ranging request on one initiator and a navigation application initiating the ranging request on another initiator, the navigation application should be given priority.

In a block 806, the method 800 receives ranging measurement requests from one or more initiators according to the initiator prioritization scheme and according to the channel map availability. In keeping with the example, Kent's mobile device 902 receives ranging measurement requests from one or more or his family members and/or friends according to the initiator prioritization scheme and according to the advertised channel map availability.

In a block 808, the method 800 responds to the ranging measurement requests from the one or more initiators. In one or more implementations, in the block 808 the ranging measurement requests are responded to based on a responder prioritization scheme. The responder prioritization scheme may be the same as the initiator prioritization scheme or different from the responder prioritization scheme.

In keeping with the example, one or more of Kent's family members and/or friends respond to the ranging measurement request in the order that is determined autonomously by the autonomous initiator prioritization scheme described above. Additionally, if there is an implicit priority order or importance order due to the service running on the initiator, services that refresh more frequently could be given higher priority over services that refresh less frequently. Also, if a web browser is initiating the ranging request on one initiator and a navigation application initiating the ranging request on another initiator, the navigation application could be given priority including implicit priority ordering, importance ordering due to the service running on the initiator, as well as web browser is initiating the ranging request on one initiator and a navigation application initiating the ranging request on another initiator, the navigation application should be given priority.

In one or more implementations, a secondary responder awakens to respond to initiator ranging requests to it based on the channel availability map and information relating to the N devices. If the ranging measurements are not concluded during the DW cycle (32, 16 ms slots) while the second/third/fourth responder is still ranging to initiators, then the second/third/fourth responder will advertise a channel availability map at the beginning of the next DW cycle.

In an alternative implementation, one of the other friends or family members besides Kent wants to perform ranging to one of the other mobile devices 904A, 904B, 904C, or 904D. In this scenario, one of the other family/friend mobile devices 904A, 904B, 904C, and 904D transmits an N×N ranging request to Kent's mobile device 902 via the communication entity 906 located in the cloud 908.

In still another implementations, the upper layer application 910 may initiate ranging to one of the other mobile devices 904A, 904B, 904C, or 904D or receives a ranging request forwarded from the upper layer entity 906 located in the cloud 908. In a further implementation, another service running on the HLOS 912 may initiate ranging to one of the other mobile devices 904A, 904B, 904C, or 904D.

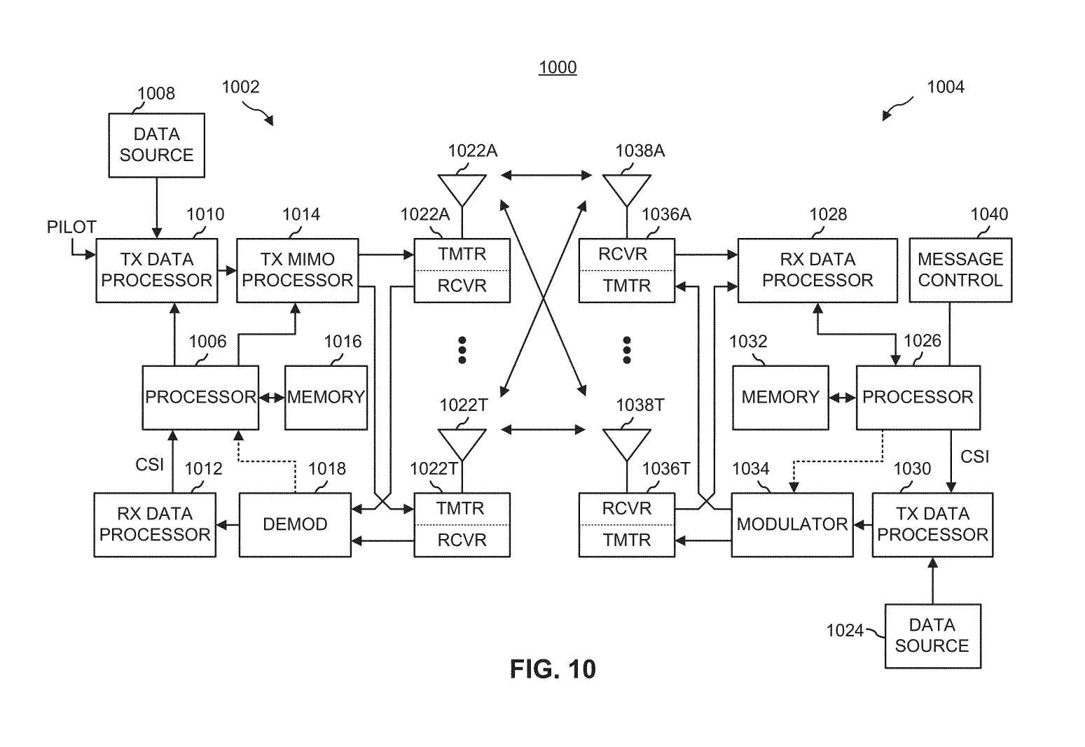

FIG. 10 is a block diagram of a broadband wireless communications network, network 1000, according to an example implementation of the technology described herein, in which a lead responder can receive and accommodate the RTT ranging measurement requests from several initiators in the same DW and in an order that is autonomously determined by the initiators. The network 1000 includes a mobile device 1002 and a mobile device 1004. A third mobile device (not shown) implementing the technology described herein may have the same or similar components and functions as those described with reference to mobile device 1002 and mobile device 1004.

The mobile device 1002 is further configured to receive the second message and to calculate a RTT estimation using the time-of-arrival estimation of the start of first acknowledgement, time t4, the first message transmission time t1, the first message duration time, and a predetermined constant representing a short time interval (Short Interframe Space (SIFS)).

In the illustrated implementation, the mobile device 1002 includes a processor 1006, a data source 1008, a transmit (TX) data processor 1010, a receive (RX) data processor 1012, a transmit (TX) multiple-input multiple-output (MIMO) processor 1014, a memory 1016, a demodulator (DEMOD) 1018, several transceivers (TMTR/RCVR) 1020A through 1020T, and several antennas 1022A through 1022T.

In the illustrated implementation, the mobile device 1004 includes a data source 1024, a processor 1026, a receive data processor 1028, a transmit (TX) data processor 1030, a memory 1032, a modulator 1034, several transceivers (TMTR/RCVR) 1036A through 1036T, several antennas 1038A through 1038T, and a message control module 1040.

The illustrated mobile device 1002 may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations, the mobile device 1002 may be a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

The illustrated mobile device 1004 may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

The illustrated data source 1008 provides traffic for a number of data streams to the TX data processor 1010.

The TX data processor 1010 formats, codes, and interleaves the traffic data for each data stream based on a particular coding scheme selected for that data stream to provide coded data. The coded data for each data stream may be multiplexed with pilot data using Orthogonal Frequency Division Multiple Access (OFDM) techniques.

The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols.

The data rate, coding, and modulation for each data stream may be determined by instructions performed by the TX data processor 1010. The memory 1016 may store program code, data, and other information used by the TX data processor 1010 or other components of the mobile device 1002.

The modulation symbols for all data streams are then provided to the TX MIMO processor 1014, which may further process the modulation symbols (e.g., for OFDM). The TX MIMO processor 1014 then provides modulation symbol streams to the transceivers (XCVR) 1020A through 1020T. In some implementations, the TX MIMO processor 1014 applies beam-forming weights to the symbols of the data streams and to the antenna from which the symbol is being transmitted.

Each transceiver (XCVR) 1020A through 1020T receives and processes a respective symbol stream to provide one or more analog signals, and further conditions (e.g., amplifies, filters, and upconverts) the analog signals to provide a modulated signal suitable for transmission over the MIMO channel. Modulated signals from transceivers (XCVR) 1020A through 1020T are then transmitted from antennas 1022A through 1022T, respectively.

At the mobile device 1004, the transmitted modulated signals are received by antennas 1038A through 1038T and the received signal from each antenna 1038A through 1038T is provided to a respective transceiver (XCVR) 1036A through 1036R. Each transceiver (XCVR) 1036A through 1036R conditions (e.g., filters, amplifies, and downconverts) a respective received signal, digitizes the conditioned signal to provide samples, and further processes the samples to provide a corresponding “received” symbol stream.

The receive (RX) data processor 1028 then receives and processes the received symbol streams from the transceivers (XCVR) 1036A through 1036T based on a particular receiver processing technique to provide “detected” symbol streams. The receive (RX) data processor 1028 then demodulates, deinterleaves, and decodes each detected symbol stream to recover the traffic data for the data stream. The processing by the receive (RX) data processor 1028 is complementary to that performed by the TX MIMO processor 1014 and the TX data processor 1010 at the mobile device 1002.

The processor 1026 periodically determines which pre-coding matrix to use (discussed below). The processor 1026 formulates a reverse link message comprising a matrix index portion and a rank value portion.

The memory 1032 may store program code, data, and other information used by the processor 1026 or other components of the mobile device 1004.

The reverse link message may comprise various types of information regarding the communication link and/or the received data stream. The reverse link message is then processed by a TX data processor 1030, which also receives traffic data for a number of data streams from the data source 1024, modulated by the modulator 1034, conditioned by the transceivers (XCVR) 1036A through 1036R, and transmitted back to the mobile device 1002.

At the mobile device 1002, the modulated signals from the mobile device 1004 are received by the antennas 1022A through 1022T conditioned by the transceivers (XCVR) 1020A through 1020R, demodulated by a demodulator (DEMOD) 1018, and processed by the RX data processor 1012 to extract the reverse link message transmitted by the mobile device 1004. The TX data processor 1010 then determines which pre-coding matrix to use for determining the beam-forming weights then processes the extracted message.

It should be appreciated that for the mobile device 1002 and the mobile device 1004 the functionality of two or more of the described components may be provided by a single component. For example, a single processing component may provide the functionality of the message control module 1040 and the processor 1026.

It also should be appreciated that a wireless node may be configured to transmit and/or receive information in a non-wireless manner (e.g., via a wired connection). Thus, a receiver and a transmitter as discussed herein may include appropriate communication interface components (e.g., electrical or optical interface components) to communicate via a non-wireless medium.

The network 1000 may implement any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication network employing the teachings herein may be designed to implement one or more standards, such as IS-95, cdma2000, IS-856, W-CDMA, TDSCDMA, and other standards.

A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95, and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication network (UMTS).

The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2).

Although certain aspects of the disclosure may be described using 3GPP terminology, it is to be understood that the teachings herein may be applied to 3GPP (e.g., Re199, Re15, Re16, Re17) technology, as well as 3GPP2 (e.g., 1×RTT, 1×EV-DO Re10, RevA, RevB) technology and other technologies.

Aspects of the technology described herein and related drawings are directed to specific implementations of the technology. Alternative implementations may be devised without departing from the scope of the technology described herein. Additionally, well-known elements of the technology will not be described in detail or will be omitted so as not to obscure the relevant details.

Although steps and decisions of various methods may have been described serially in this disclosure, some of these steps and decisions may be performed by separate elements in conjunction or in parallel, asynchronously or synchronously, in a pipelined manner, or otherwise. There is no particular requirement that the steps and decisions be performed in the same order in which this description lists them, except where explicitly so indicated, otherwise made clear from the context, or inherently required. It should be noted, however, that in selected variants the steps and decisions are performed in the order described above. Furthermore, not every illustrated step and decision may be required in every implementation/variant in accordance with the technology described herein, while some steps and decisions that have not been specifically illustrated may be desirable or necessary in some implementation/variants in accordance with the technology described herein.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the implementations disclosed herein may be implemented as electronic hardware, computer software, or combinations of both. To show clearly this interchangeability of hardware and software, various illustrative components, blocks, modules, circuits, and steps have been described above generally in terms of their functionality. Whether such functionality is implemented as hardware, software, or combination of hardware and software depends upon the particular application and design constraints imposed on the overall system. Skilled artisans may implement the described functionality in varying ways for each particular application, but such implementation decisions should not be interpreted as causing a departure from the scope of the present technology described herein.

The various illustrative logical blocks, modules, and circuits described in connection with the implementation disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be implemented directly in hardware, in a software module executed by a processor, or in a combination of the two. A software module may reside in random-access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an access terminal. Alternatively, the processor and the storage medium may reside as discrete components in an access terminal.

The previous description of the disclosed implementations is provided to enable any person skilled in the art to make or use the technology described herein. Various modifications to these implementations will be readily apparent to those skilled in the art, and the generic principles defined herein may be applied to other implementations without departing from the spirit or scope of the technology described herein. Thus, aspects of the technology described herein are not intended to be limited to the implementations shown herein, but is to be accorded the widest scope consistent with the principles and novel features disclosed herein.

What is claimed is:

1. A method for ranging in a communication network, the method comprising:
receiving an N×N ranging measurement request from an upper layer entity;
responding to the N×N ranging measurement request by advertising a channel availability map at a beginning of a DW cycle, wherein the channel availability map includes a list of slots and channels;
receiving one or more ranging measurement requests from one or more initiators based on an initiator prioritization scheme and the channel availability map; and
responding to the ranging measurement requests from the one or more initiators.

2. The method of claim 1, further comprising receiving the one or more ranging measurement requests from the one or more initiators after the ranging measurement request from the upper layer entity in an order determined autonomously by a first initiator of the one or more initiators and the one or more initiators, wherein the order that is determined autonomously by the first initiator and the one or more initiators is selected from an ascending order, a descending order, an order selected using one or more hash function, an implicit priority order, or an importance order based on a service running on the initiator.

3. The method of claim 2, wherein the order that is determined autonomously by the first initiator and the one or more initiators is based on a MAC address for the first initiator and a MAC address for the second initiator.

4. The method of claim 1, wherein a secondary responder awakens to respond to initiator requests to it based on the channel availability map and information relating to the N devices.

5. The method of claim 4, wherein if the ranging measurements are not concluded during the DW cycle while at least one of a second, third, or fourth responder is still ranging to initiators, then the second, third, or fourth responder will advertise a channel availability map at the beginning of the next DW cycle.

6. The method of claim 1, wherein the ranging measurement requests from the first initiator and the one or more initiators are received substantially simultaneously.

7. The method of claim 1, further comprising communicating a ranging measurement value to the initiator using a vendor-specific Information Element.

8. The method of claim 7, wherein the vendor-specific Information Element is included in an FTMStop frame.

9. The method of claim 1, wherein responding to the ranging measurement requests from the one or more initiators is based on a responder prioritization scheme.

10. An apparatus for ranging in a communication network, the apparatus comprising:
logic configured to receive an N×N ranging measurement request from an upper layer entity;
logic configured to respond to the N×N ranging measurement request by advertising a channel availability map at a beginning of a DW cycle, wherein the channel availability map includes a list of slots and channels;
logic configured to receive one or more ranging measurement requests from one or more initiators based on an initiator prioritization scheme and the channel availability map; and
logic configured to respond to the ranging measurement requests from the one or more initiators.

11. The apparatus of claim 10, further comprising logic configured to receive the one or more ranging measurement requests from the one or more initiators after the ranging measurement request from the upper layer entity in an order determined autonomously by a first initiator of the one or more initiators and the one or more initiators, wherein the order that is determined autonomously by the first initiator and the one or more initiators is selected from an ascending order, a descending order, an order selected using one or more hash function, an implicit priority order, or an importance order based on a service running on the initiator.

12. The apparatus of claim 11, wherein the order that is determined autonomously by the first initiator and the one or more initiators is based on a MAC address for the first initiator and a MAC address for the second initiator.

13. The apparatus of claim 10, wherein a secondary responder is configured to awaken to respond to initiator requests to it based on the channel availability map and information relating to the N devices.

14. The apparatus of claim 13, wherein if the ranging measurements are not concluded during the DW cycle while at least one of a second, third, or fourth responder is still ranging to initiators, then the second, third, or fourth responder are configured to advertise a channel availability map at the beginning of the next DW cycle.

15. The apparatus of claim 10, wherein the ranging measurement requests from the first initiator and the one or more initiators are received substantially simultaneously.

16. The apparatus of claim 10, further comprising logic configured to communicate a ranging measurement value to the initiator using a vendor-specific Information Element.

17. The apparatus of claim 16, wherein the vendor-specific Information Element is included in an FTMStop frame.

18. The apparatus of claim 10, wherein responding to the ranging measurement requests from the one or more initiators is based on a responder prioritization scheme.

19. An apparatus for ranging in a communication network, the method comprising:
means for receiving an N×N ranging measurement request from an upper layer entity;
means for responding to the N×N ranging measurement request by advertising a channel availability map at a beginning of a DW cycle, wherein the channel availability map includes a list of slots and channels;
means for receiving one or more ranging measurement requests from one or more initiators based on an initiator prioritization scheme and the channel availability map; and
means for responding to the ranging measurement requests from the one or more initiators.

20. The apparatus of claim 19, further comprising means for receiving the one or more ranging measurement requests from the one or more initiators after the ranging measurement request from the upper layer entity in an order determined autonomously by a first initiator of the one or more initiators and the one or more initiators, wherein the order that is determined autonomously by the first initiator and the one or more initiators is selected from an ascending order, a descending order, an order selected using one or more hash function, an implicit priority order, or an importance order based on a service running on the initiator.

21. The apparatus of claim 20, wherein the order that is determined autonomously by the first initiator and the one or more initiators is based on a MAC address for the first initiator and a MAC address for the second initiator.

22. The apparatus of claim 19, wherein a secondary responder awakens to respond to initiator requests to it based on the channel availability map and information relating to the N devices.

23. The apparatus of claim 22, wherein if the ranging measurements are not concluded during the DW cycle while at least one of a second, third, or fourth responder is still ranging to initiators, then the second, third, or fourth responder further comprise means for advertising a channel availability map at the beginning of the next DW cycle.

24. The apparatus of claim 19, wherein the ranging measurement requests from the first initiator and the one or more initiators are received substantially simultaneously.

25. The apparatus of claim 19, further comprising means for communicating a ranging measurement value to the initiator using a vendor-specific Information Element.

26. The apparatus of claim 25, wherein the vendor-specific Information Element is included in an FTMStop frame.

27. The apparatus of claim 19, wherein the means for responding to the ranging measurement requests from the one or more initiators is based on a responder prioritization scheme.

28. A computer-readable storage medium including data that, when accessed by a machine, cause the machine to perform operations in a wireless communication network, the operations comprising:
receiving an N×N ranging measurement request from an upper layer entity;
responding to the N×N ranging measurement request by advertising a channel availability map at a beginning of a DW cycle, wherein the channel availability map includes a list of slots and channels;
receiving one or more ranging measurement requests from one or more initiators based on an initiator prioritization scheme and the channel availability map; and
responding to the ranging measurement requests from the one or more initiators.

29. The computer-readable storage medium of claim 28, further comprising data that, when accessed by the machine, cause the machine to perform operations comprising receiving the one or more ranging measurement requests from the one or more initiators after the ranging measurement request from the upper layer entity in an order determined autonomously by a first initiator of the one or more initiators and the one or more initiators, wherein the order that is determined autonomously by the first initiator and the one or more initiators is selected from an ascending order, a descending order, an order selected using one or more hash function, an implicit priority order, or an importance order based on a service running on the initiator.

30. The computer-readable storage medium of claim 29, wherein the order that is determined autonomously by the first initiator and the one or more initiators is based on a MAC address for the first initiator and a MAC address for the second initiator.
